(19) United States
(12) Patent Application Publication
(10) Pub. No.: US 2024/0399308 A1
(43) Pub. Date: Dec. 5, 2024

(54) AIRFOIL CATALYTIC REACTOR FOR ATMOSPHERIC AIR TREATMENT

(71) Applicant: Bomvento Ltd, Haifa (IL)

(72) Inventor: Nir MAROM, Tzur Moshe (IL)

(21) Appl. No.: 18/698,880

(22) PCT Filed: Sep. 30, 2022
(86) PCT No.: PCT/US2022/045294

§ 371 Date: Apr. 5, 2024

Related U.S. Application Data
(60) Provisional application No. 63/252,299, filed on Oct. 5, 2021.

(51) Int. Cl. B01D 53/88

(52) U.S. Cl. CPC B01D 53/885; B01D 2255/104; B01D 2255/20707; B01D 2255/20792; B01D 2255/802; B01D 2257/402; B01D 2257/7025; B01D 2258/06; B01D 2259/802

(57) ABSTRACT

Some embodiments relate to the novel use of aerodynamic airfoil wing profiles in general and specifically aerodynamic horizontal wind turbine wings (“wings” or “blades”) covered with catalytic materials as an open-air catalytic reactor, and in particular as a scalable and effective means for atmospheric air treatment and removal of pollutants and other harmful gases. The catalytic material interacts with pollutants as air flows over the airfoil. The aerodynamic shape and the airflow pattern over such a shape increases the likelihood of a catalytic reaction. In addition, the typical use of airfoil wings is with air flowing over them. This is certainly the case in airfoil wings of wind turbines. The movement of the blades in huge quantities of air allows for effective processing of significant air volumes and thus a reduction of large quantities of harmful gases.

### CROSS-REFERENCE TO RELATED APPLICATIONS

This application is a national phase filing under 35 C.F.R. § 371 of and claims priority to PCT Patent Application No. PCT/US2022/045294, filed on Sep. 30, 2022, which claims the priority benefit under 35 U.S.C. § 119 of U.S. Patent Application No. 63/252,299, filed on Oct. 5, 2021, the contents of which are hereby incorporated in their entireties by reference.

### TECHNICAL FIELD OF THE INVENTION

The present invention relates to technologies for the effective deployment and use of catalysts to interact with as much pollutants as possible. Most likely this will be used in the context of atmospheric greenhouse gas (GHG) removal.

Specifically, this invention relates to the novel use of aerodynamic airfoil wing profiles in general and horizontal axis wind turbine aerodynamic wings (“wings” or “blades”) in particular, coated with catalytic materials, as an open-air catalytic reactor.

### BACKGROUND ART

Green-house gases (“GHG”) are gases in the earth's atmosphere that cause a greenhouse effect. As their concentration grew, they became an environmental hazard, causing increases in the average earth temperature. Removal of GHGs from the earth atmosphere is considered a necessity.

Many GHGs can be removed from the atmosphere by means of catalysis and specifically photocatalysis (photocatalytic oxidation, or “PCO”), but the challenge is doing so in an economically viable manner. One main barrier is the fact that concentrations of GHGs in the atmosphere are low. For example, carbon dioxide is 410 ppm (parts per million) of the atmospheric air, methane is 1.9 ppm and nitrous oxide is only 0.3 ppm (the three most harmful GHG). Concentrations of other GHGs are even significantly lower by orders of magnitude and often measured in ppb and ppt (parts per billion/trillion). As a result, huge quantities of air need to be effectively processed to remove relatively low amounts of GHG.

A related field of study is in the development of Photocatalytic Reactors. The key considerations for photocatalytic reactors are effective mass transfer of pollutants (GHGs in this case) to the photocatalyst surface and effective illumination of the photocatalyst at the same time. As one paper phrased it: “The design, optimization, and scale-up of photocatalytic reactors are challenging issues for the commercialization of photocatalytic air purification. Optimization of the PCO reactor is more complex than that of typical heterogeneous catalytic reactors, as the PCO process should consider both mass transfer and light delivery parameters” (F. He et al, “Photocatalytic air purification mimicking the self-cleaning process of the atmosphere”, Nature Communications, 2021).

The challenge is getting significant amounts of the pollutant and GHGs to the catalytic surface with the right lighting. But this is not enough. Not each pollutant/GHG molecule that touches or gets close to a catalyst molecule will interact. For example, in photocatalysis there is a limited time window when the catalyst has recently been “loaded” by a light photon for it to be ready to interact. As a result, the reaction is “statistical” in its nature—it may occur and may not. In a reactor design there is an advantage if the pollutant meets many catalytic molecules, as it increases the likelihood of the reaction happening.

This is even more important in the context of the low concentrations of GHGs in the atmosphere, making the engineering challenge a great one. For example, to eliminate one cubic meter of Methane from the atmosphere, and even assuming 100% elimination, over 500,000 cubic meters of air need to be processed. This number jumps to over 3 million cubic meters of air for 1 cubic meter of Nitrous Oxide, and Trillions of cubic meters of air for many other GHGs.

Getting enough catalytic material to interact with enough air, at the right humidity, temperature and lighting requires huge facilities that have massive airflow. Typically, this will require a combination of high construction costs and high energy cost in getting enough air flow, making the commercial economic justification problematic.

Deployment on large static surfaces as an alternative has many disadvantages and shows mixed results often considerably lower than the theoretical potential. The use of static surfaces was tested in scale not for GHGs but for treatment of NOx pollutants. Passive photocatalyst coatings were applied on street walls and sidewalks and in tunnels. The success was limited. One of the problems was in transport limitations of the pollutants towards the active surfaces (ie airflow towards the passive surface) and where ambient light was used, changes in light and shading reduced the impact.

Use of wind facing screens and Savonius turbines (vertical axis “drag” turbines where wind pushes on screens or scoops) is another possibility, however, such do not exist in the mass numbers and size needed. Moreover, the flow of air on a sail is also not optimal when the target is to enhance probability of a catalytical interaction, as the air “hits” the sale and does not flow over it as it does in lift type aerodynamic airfoil structures.

One (currently theoretical) potential solution is utilizing solar chimney power plants which are inherently large and have high air flow through them. (See R. de Richter et al, “Removal of non-CO2 greenhouse gases by large-scale atmospheric solar photocatalysis”, Progress in Energy and Combustion Science, 2017. This paper also provides good background on general removal of GHG by means of catalysis). However, solar chimney power plants are not deployed in full scale.

It is apparent that a need exists for a means to deploy catalyst materials that can treat pollutants and GHGs in a scalable manner, on large surfaces where significant air flows can transport the GHG to the catalyst and where there is ample light. The present invention is directed toward providing such a technique.

In recent years, many theoretical and laboratory advancements have been made in chemical reactions to eliminate GHGs. A specific field of interest for this matter is photocatalysis of GHGs—removal of GHGs by way of photo-reaction, enhanced by a catalyst. By their nature, photocatalytic reactions require light. Often ultra-violet. Many such reactions also require high temperatures. Much of the research is in finding the right materials for photocatalysis in ambient light and temperature. A good summary can be seen in the above mentioned—R. de

Richter et al, “Removal of non-CO2 greenhouse gases by large-scale atmospheric solar photocatalysis”, Progress in Energy and Combustion Science, 2017.

In terms of systems, U.S. Pat. No. 5,919,422A describes a photo-catalyzer for deodorizing, cleaning, sterilizing, and water purifying operations includes a substrate, a titanium dioxide film disposed on the substrate and functioning as a photo-catalyst, and a light-emitting diode.

US20060280660A1 describes a Photocatalytic air purifier system that includes a photocatalyst coated surface and a light source as an indoor photocatalytic air purification system.

CN1 03127926 A describes a photocatalytic material used for nitric oxide (N2O) catalytic purification and preparation method.

Other, non-photocatalytic methods are considered for atmospheric removal of GHGs, for example US patents US20170113184 A1 and US11389761B1 describe systems and methods for carbon dioxide from ambient air, but both require fans to bring air into said systems.

However, in all cases the issue remains the same—getting enough air and ppm/ppb concentrations of pollutants onto the photocatalytic material in a scalable, economic manner.

By looking at prior art, in response to the need of reducing greenhouse gases in the environment various approaches and systems have been attempted. However, these solutions are limited and restricted and to the applicant's knowledge, no scalable or economical system has been developed, let alone deployed to date.

The current invention allows for the economic, scalable catalytic processing of huge amounts of air, pollutants and greenhouse gases. The overall combination of the current invention's features is nowhere disclosed in the prior art cited above, which appears to represent the general art in this area, although it is not intended to be an all-inclusive listing of pertinent prior art patents.

### DISCLOSURE OF INVENTION

### Summary

In light of the disadvantages of the prior art, the following summary is provided to facilitate an understanding of some of the innovative features unique to the present invention and is not intended to be a complete description. A full appreciation of the various aspects of the invention can be gained by taking the entire specification, claims, drawings, and abstract as a whole.

The present subject matter and objective of the innovation is to provide an improved, scalable and economical open-air catalytic reactor, for treatment of atmospheric pollutants and greenhouse gases (GHG) by utilizing airfoils and wind turbine airfoils.

This and other objects are achieved in accordance with the present invention by providing an aerodynamic airfoil wing shape coated with catalytic material. The unique airflow on such airfoil wing surface sends each pollutant molecule over a long surface of catalyst, thus increasing the likelihood of catalytic interaction between the pollutant and the catalytic surface.

It is also the objective of the invention to provide airflow onto the catalytic reactor with no or minimal energy requirement. By the nature of their original usage air flows over airfoil wings (Wings in general and wind turbine wings specifically). By coating airfoils traveling through air and specifically aerodynamic airfoil wings of wind turbines with catalytic material, the system benefits from both the unique airflow on the airfoil wing surface and from the huge quantities of air the airfoil moves through, thus increasing the amount of pollutants reaching the catalytic surface as well as the likelihood of catalytic interaction between the pollutant and the catalytic surface.

As per a further objective of the invention, light (required for photocatalysis) is naturally available most of the day. In addition, the small footprint of the wings makes augmenting daylight with artificial light sources (if needed) more economical in comparison to the lighting of huge surfaces.

As per another objective of the invention, some of the surface fouling is naturally cleaned (wind, rain, and spinning—changing gravitational direction and centrifugal forces).

Finally, utilizing existing airfoils provides them with dual usage functionality. The airfoils continue providing their original intended functionality (for example electricity generation in the case of wind turbines or flying in the case of airplane wings), and the new pollutant cleaning functionality is added as a “positive side effect”. Revenue potential is increased while initial investment and operating costs are significantly lower than doing each function separately.

Further detail regarding the apparatus and system in accordance with the present invention may be had with reference to the detailed description which is provided below, taken in conjunction with the following illustrations.

### DETAILED DESCRIPTION

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices.

Catalysis of pollutants and GHGs into non or less harmful materials has been a known phenomenon for many years. Nevertheless, the great challenge of effective, commercial large-scale deployment still remains. A key problem that needs to be overcome is getting huge quantities of air on a catalytic surface, within the right reaction window, under the right ambient conditions and lighting.

The current invention presents the use of aerodynamic airfoil wing shapes coated with catalytic material as an open-air reactor for atmospheric pollutants and greenhouse gas (GHG) treatment (see FIG. 1).

As per an embodiment of the invention, the advantages of using an aerodynamic airfoil coated with catalytic material as an open-air reactor are in the specific flow patterns of air around the airfoil (speed and pressure) and the fact that the air travels a distance in close proximity to the catalytic surface (see FIG. 2).

The flow over the catalytic surface increases the likelihood of the chemical reaction happening. In many catalytic reactions, and specifically in photocatalysis, several reactions must occur simultaneously and the chance of a pollutant or GHG interacting increases if the reaction window is longer compared with a “one time collision” when airflow is vertical to the surface (see FIG. 3).

Increasing the likelihood of the reaction is very important in open air, low-concentration scenarios. Under such scenarios, it is important that once a “rare” molecule reaches the photocatalyst it reacts. Otherwise, in open air, the likelihood of catching this molecule again is very low. Moreover, different catalysts or different surface textures can be used over the wing surface to further increase the likelihood of a reaction within the “reaction window”.

Such airfoil shapes can be static or dynamic, with the sole purpose of pollutant removal or with additional purposes (eg airplane or wind turbine wings) but in any case, the air flow characteristics (speed, pressure, length of travel) will increase the likelihood of the pollutant reaction with the catalyst.

An example deployment of a dedicated airfoil GHG reduction facility can be a field of low-cost airfoil shaped structures, covered with photocatalysts, standing in a known high wind area. In this example, the structures can rotate to face the wind (see FIG. 4).

The current invention also presents the use of aerodynamic airfoils of horizontal axis wind turbines (HAWT) coated with catalytic material as an open-air reactor for atmospheric pollutants and GHG treatment.

HAWT have been deployed for decades and produce the overwhelming majority of wind power in the world.

Coating HAWT aerodynamic wings with catalyst can bring many benefits as an open-air catalytic reactor for atmospheric pollutants. The airfoil shaped wings of wind turbines circulate through massive amounts of air, in open daylight (when available). No new structures are needed, no energy is needed to generate airflow and no or little energy is required to provide lighting. Aerodynamic wings of horizontal axis wind turbines were never considered for GHG removal because their use is counterintuitive in two ways: 1. Traditional use cases looked for large surfaces to deploy photocatalysts—Large city buildings, inner walls of tunnels, huge solar chimney power plants (photocatalyst surface of several sq kilometers). On the contrary, the wings of HAWTs are thin structures that cover only a small portion of the total swept rotor area (see FIG. 5).

The airflow profile is different and counterintuitive in itself. Traditional use cases looked for surfaces that face the wind, where the air hits the surface in as much as a vertical angle as possible (for example walls of buildings, sails and drag type vertical axis Savonius turbines), whereas in aerodynamic wings the air flows mostly over and under the wing. As mentioned above, this continuous flow of the air in close proximity to the photocatalytic surface can increase the likelihood of the chemical reaction compared with a “one time collision” where airflow is vertical to the surface.

A typical HAWT has several wings (most common 3) and is manufactured in a wide range of sizes, with large wings at lengths of over 100 meters each. Such wings have a very large swept area (over 31,000 sq meters for a 100 m blade), and even though the blades are very small in comparison to their swept area each blade sweeps many times per minute and significant amounts of air are swept on an ongoing basis.

As per further embodiments of the invention, airfoils in general, and HAWT airfoil wings specifically, will be covered catalytic material, most likely photocatalytic materials that utilize light and a catalysis to induce chemical reactions. The catalyst can fully cover all parts of the airfoil or partially cover specific parts. For example, covering the wing's pressure surface (a.k.a. the lower surface) and/or suction surface (a.k.a. the upper surface); the wing's tip and/or base and/or any other combination. There are advantages and disadvantages in the airflow pattern, speed and pressure of each and can be optimized for different scenarios.

The catalyst, as per further embodiments of the invention, can be one specific type, or a combination of several types (eg Ag—TiO2 optimized for N2O and Ag—ZnO optimized for CH4). The different cover areas and materials will be optimized for optimal GHG reduction (and in the case of wind turbines also optimal electricity generation) and accounting for the relevant ambient conditions (wind, sun, humidity etc.) and economics (electricity price, GHG reduction incentives and costs). For example, using photocatalyst combinations to treat different GHGs at the same time, covering parts of the wing to reduce added drag or using different catalysts on different parts of the wing to better fit the air flow over the wing.

The catalyst can be deposited on the airfoil wing by several methods. The deposition can be directly on the wing itself or by depositing the catalyst on a separate substance (for example thin film) that is later used to coat or connect to the wing. Deposition methods (on the wing, or on the separate substance) include painting, thermal spraying, sol-gel techniques, chemical/physical vapor deposition, electrophoretic deposition and more.

The deposition can be with patterns that optimize the reactions either of combinations of GHGs or of a specific GHG. These patterns can be a combination of different photocatalyst materials, different deposition methods, different surface treatment, different surface textures etc. For example (see FIG. 6 lower drawing), an optimization for several GHGs where a first stripe of coating, close to the aerodynamic wing leading edge, of photocatalyst optimal for Methane reaction (e.g. Polytungstate on TiO2); followed by a stripe optimal for N2O reaction (e.g. 1% Ag on TiO2); followed by a strip close to the aerodynamic wing trailing edge for reactions with CFCs gases (e.g. TiO2). Or as an example for optimization of a specific GHG, covering the upper and lower surfaces of the aerodynamic wing with different photocatalysts that are optimized based on the different airflows, temperatures and other factors on the pressure and the suction surfaces (see FIG. 6 top drawing).

The deposition can be done in the airfoil manufacturing facilities for new wings or in the field for retrofitting existing airfoils and turbines. It is likely that different deposition methods would be used.

Once the catalyst is deposited, and in the case of photocatalysis in the presence of light (Sunlight when available, external lighting when needed and economical) the chemical reactions can be initiated. As air flows over the airfoil blades and the present catalyst, the pollutants will react and chemically break into less harmful forms.

While at any given point relatively little GHG will be treated, the combined effect over time can be substantial.

Often using airfoils to reduce GHGs is a positive by-product, with no need to change the airfoil's main operational methods. This is true beyond wind turbines. For example, coating airplane wings. The airfoil will continue operating as it normally does, but now as it does so it will provide additional environmental benefits in GHG removal. Moreover, much of the operation is combined (moving through air, regular cleaning etc). As such, the present invention provides added economic benefit to operators, and in the case of wind turbines, reducing the cost of both clean energy and GHG removal.

It is appreciated that additional advantages, modifications and equivalent embodiments will be apparent to those skilled in the art. Therefore, the invention, in its broader aspects, is not limited to the specific details shown and described herein. Accordingly, various modifications may be made without departing from the spirit or scope of this invention as defined by the appended claims and their equivalents.

### BRIEF DESCRIPTION OF DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 shows top and bottom views of a typical airfoil. The catalyst can be coated on all and any side of the airfoil as per preferred embodiments of the invention.

FIG. 2 shows a cross-section view of flow of air over an aerodynamic airfoil profile as per preferred embodiments of the invention.

FIG. 3 shows Reaction “window” for pollutants flow over catalyst on an airfoil structure as per preferred embodiments of the invention, compared to a pollutant vertical “collision” with a catalyst.

FIG. 4 shows an example field of photocatalytic airfoil structures for GHG removal as per preferred embodiments of the invention.

FIG. 5 shows typical proportions of a horizontal axis wind turbine and the comparison of the large total area swept vs. the small airfoil size.

FIG. 6 shows the potential deposition of different catalysts on different areas of the airfoil to optimize reaction as per preferred embodiments of the invention.

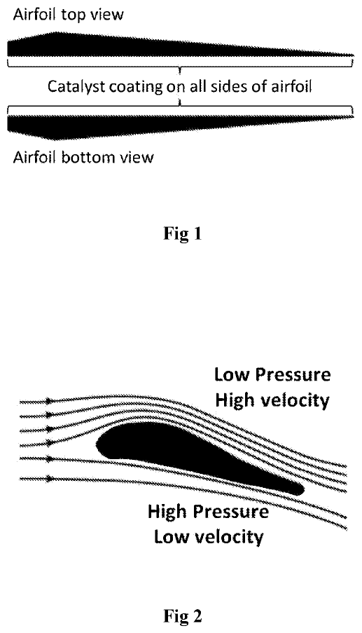

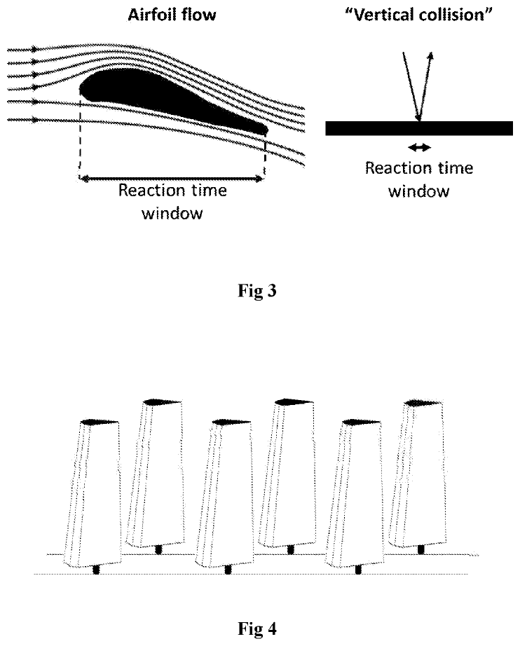

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### BEST MODE FOR CARRYING OUT THE INVENTION

The invention has many possible applications and usage scenarios. Different targeted pollutants and GHG, different airfoils, retrofit application on existing airfoils or application in airfoil manufacturing. For this best mode, we assume targeting of N2O and CH4 (2 of the 3 most problematic GHGs) on an existing wind turbine.

Ag—TiO2 is a known, well suited photocatalyst of N2O and Ag—ZnO for CH4.

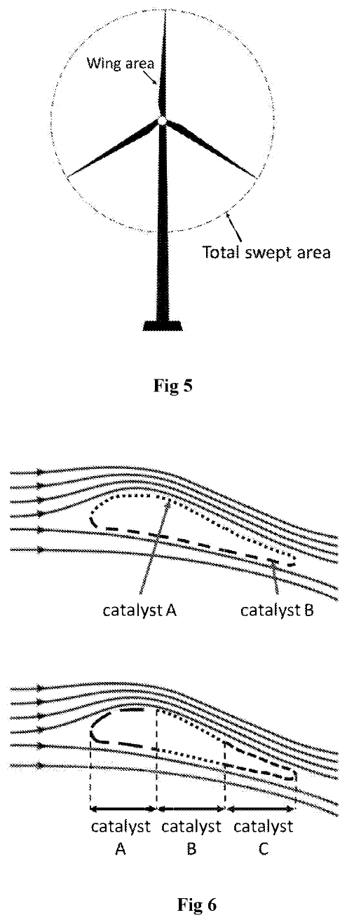

As a retrofit installation example, a good method for effective coating of the turbine airfoils is by painting of the wings. The photocatalysts would be mixed within a paint and the airfoils painted (alternatively depositing the catalysts on a thin film and then fixing the film on the airfoil by adhesion). As of our best knowledge, best results would be achieved by separate coating in patterns and in different areas of the airfoil (see FIG. 6).

As the turbine spins, large amounts of air will pass over the airfoils. As part of the air, molecules of N2O and CH4 will also pass and in daylight, will interact with catalyst cells activated by the light photons, breaking up to less harmful elements.

### INDUSTRIAL APPLICABILITY

There is a market for GHG and other pollutant removal.

Dedicated airfoils can be used for GHG and pollutant removal (see example in FIG. 4) but most economically, owners of existing airfoil structures can benefit from additional income, with very little additional costs.

Adding a layer of catalyst will add a little drag and weight, especially in retrofit applications. This can be minimized in new built airfoils. Nevertheless, depending on the airfoil original use, the little additional drag and weight would often be marginal compared with the added economic and environmental benefits. This is certainly the case for wind turbine airfoils.

1. An open-air catalytic reactor used for atmospheric air treatment and removal greenhouse gases, the open-air catalytic reactor comprising:
an airfoil;
catalytic material on the surface of said airfoil; and
an artificial light source positioned to activate the catalytic material by light delivery thereto.

2. The open-air catalytic reactor of claim 1, wherein said catalytic material comprises at least one of, a photocatalyst, a thermo-photocatalyst, and a plasma-photocatalyst.

3. The open-air catalytic reactor of claim 1, wherein said catalytic material fully covers the airfoil.

4. The open-air catalytic reactor of claim 1, wherein the catalytic material comprises a plurality of mutually distinct compositions on the same said airfoil.

5. The open-air catalytic reactor of claim 4, wherein the plurality of mutually distinct compositions are distributed on a respective plurality of mutually distinct regions.

6. The open-air catalytic reactor of claim 1, wherein said catalytic material is applied to said airfoil as catalytic material upon a film substrate.

7. (canceled)

8. The open-air catalytic reactor of claim 1, wherein said artificial light source is embedded on said airfoil.

9. The open-air catalytic reactor of claim 1, wherein said artificial light source is external to said airfoil, and projects light towards said airfoil from a distance.

10-18. (canceled)

19. The open-air catalytic reactor of claim 1, comprising a horizontal axis wind turbine; wherein the airfoil is a blade of said horizontal axis wind turbine.

20. The open-air catalytic reactor of claim 19, wherein the horizontal axis wind turbine powers the artificial light source.

21. The open-air catalytic reactor of claim 1, wherein said greenhouse gases comprise at least one of N₂O and CH₄.

22. The open-air catalytic reactor of claim 5, wherein said plurality of mutually distinct compositions of catalytic material are distributed to said respective plurality of mutually distinct regions according to positions which relatively optimize reacting with a respective greenhouse gas, according to conditions of airflow near the airfoil.

23. The open-air catalytic reactor of claim 4, wherein said mutually distinct compositions are distinguished according to which of a respective plurality of greenhouse gases they most efficiently react with.

24. The open-air catalytic reactor of claim 5, wherein said mutually distinct regions comprise at least one region on a suction surface of said airfoil.

25. The open-air catalytic reactor of claim 24, wherein said mutually distinct regions comprise at least one region on a pressure surface of said airfoil.

26. The open-air catalytic reactor of claim 5, wherein said mutually distinct regions comprise at least one region at a tip of said airfoil, and another region at a base of said airfoil.

27. The open-air catalytic reactor of claim 1, wherein said catalytic material comprises at least one of Ag—TiO₂ and Ag—ZnO.

28. The open-air catalytic reactor of claim 1, wherein said catalytic material comprises an electrocatalyst.

29. An open-air catalytic reactor used for atmospheric air treatment and removal of greenhouse gases, the open-air catalytic reactor comprising:
at least one airfoil of a horizontal axis wind turbine;
catalytic material on the surface of said airfoil; and
an artificial light source positioned to illuminate the at least one airfoil and activate the catalytic material by light delivery thereto.

30. A method of catalyzing removal of greenhouse gases from atmospheric air, comprising:
providing an airfoil coated with a catalytic material;
moving said airfoil through atmospheric air as a rotating blade of a horizontal axis wind turbine; and
illuminating the catalytic material using an artificial illumination source, while the airfoil is rotating.
